(19) United States
(12) Patent Application Publication
(10) Pub. No.: US 2026/0251800 A1
(43) Pub. Date: Aug. 27, 2026

(54) AVOIDING GEOLOCATION WITH ORCHESTRATED, MULTIPLE SIGNAL GENERATION SOURCES

(71) Applicant: Kratos Integral Holdings LLC, San Diego, CA (US)

(72) Inventors: Kelly Modrick, San Diego, CA (US); Chris Badgett, San Diego, CA (US); Brandon King, San Diego, CA (US)

(73) Assignee: Kratos Integral Holdings LLC, San Diego, CA (US)

(21) Appl. No.: 19/547,122

(22) Filed: Feb. 23, 2026

Related U.S. Application Data
(60) Provisional application No. 63/762,514, filed on Feb. 24, 2025.

(51) Int. Cl. G01S 19/01; G01S 5/02

(52) U.S. Cl. CPC G01S 19/015; G01S 5/0289

(57) ABSTRACT

Described herein are systems, methods, and other techniques for orchestrating radio frequency transmissions directed toward a monitoring satellite. A controller determines a target arrival time at which signals are to arrive at the monitoring satellite. For each of a plurality of signal generator sites distributed at distinct geographic locations, the controller calculates a propagation delay from the respective signal generator site to the monitoring satellite. Based on the target arrival time and the calculated propagation delays, the controller determines a start time for each of the plurality of signal generator sites such that signals transmitted by the sites arrive at the monitoring satellite substantially simultaneously. The determined start times are communicated via a communication link to the signal generator sites, causing each site to transmit a signal at the determined start time.

### CROSS-REFERENCE TO RELATED APPLICATIONS

This application claims priority to U.S. Provisional Application No. 63/762,514, filed February 24, 2025, the contents of which are hereby incorporated in its entirety by reference.

### BACKGROUND OF THE INVENTION

Satellite communication systems play an important role in facilitating global connectivity across diverse applications, including telecommunications, broadcasting, internet services, and remote sensing. These systems generally operate by transmitting signals between ground-based Earth stations and satellites in orbit. A typical network configuration includes a gateway or hub in communication with a set of remote terminals via a satellite relay, where the satellite repeats wireless signals from the gateway to the terminals or vice versa. These systems enable data exchange by bridging terrestrial networks with space-based assets.

### SUMMARY OF THE INVENTION

Some embodiments of the present disclosure relate to techniques for avoiding geolocation by using orchestrated, multi-site signal generation. The system utilizes a centralized controller to manage a plurality of geographically dispersed signal generator (sig-gen) sites. One objective may be to deny a monitoring entity the ability to isolate a specific signal of interest. This is achieved by transmitting similar or identical signals from multiple locations simultaneously. The controller tightly orchestrates the transmission start times and power levels of each signal generator. By accounting for the unique propagation delay and path loss from each sig-gen site to a known monitoring satellite (or satellites), the controller ensures that all signals arrive at the monitoring satellite at the same instant and with substantially identical power levels.

When the signals arrive at the monitoring sensor simultaneously and with equal power, they superimpose constructively or destructively in a manner that prevents the monitoring system from distinguishing individual signal paths. Consequently, time difference of arrival (TDoA) and frequency difference of arrival (FDoA) algorithms, which rely on isolating a distinct reference signal to calculate time/frequency differences, are rendered ineffective.

Notable to this implementation is that the system does not require strict phase coherence between the transmitters, nor does it require the transmission of decodable data. The signals may be carrier tones, modulated waveforms, noise sources, comb sequences, chirp signals, among other possibilities. The lack of a requirement for strict phase locking or data decoding simplifies the hardware implementation, allowing for the use of virtualized network functions (VNFs) to generate the signals.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and various ways in which it may be practiced.

FIG. 1 illustrates a system for avoiding geolocation comprising a centralized controller and a plurality of distributed signal generator sites, in accordance with some embodiments of the present disclosure.

FIG. 2 illustrates detailed components of a controller and a signal generator site, including orchestration tools and timing modules, in accordance with some embodiments of the present disclosure.

FIG. 3 illustrates a timing diagram for orchestrated signal generation depicting staggered start times and power levels, in accordance with some embodiments of the present disclosure.

FIG. 4 illustrates a flowchart of a method for orchestrating signal transmissions to prevent geolocation, in accordance with some embodiments of the present disclosure.

FIG. 5 illustrates an example communication path between end points enabled by a satellite communication system, in accordance with some embodiments of the present disclosure.

FIG. 6 illustrates an example satellite communication system including a gateway and a set of remote terminals, in accordance with some embodiments of the present disclosure.

FIG. 7 illustrates an example digital IF packet with multiple protocol layers used for transporting digital waveforms, in accordance with some embodiments of the present disclosure.

FIG. 8 illustrates an example method of orchestrating radio frequency transmissions directed toward a monitoring satellite, in accordance with some embodiments of the present disclosure.

FIG. 9 illustrates an example computer system comprising various hardware elements capable of implementing the systems and methods described herein, in accordance with some embodiments of the present disclosure.

### DETAILED DESCRIPTION OF THE INVENTION

Satellite communication systems play an important role in facilitating global connectivity across diverse applications, including telecommunications, broadcasting, internet services, and remote sensing. These systems operate by transmitting signals between ground-based Earth stations and satellites in orbit. The efficiency and reliability of such systems are important for meeting the increasing demands of contemporary communication and data services. Presently, however, communications engineers and operators encounter significant challenges in maintaining the security and survivability of these links against increasingly sophisticated monitoring tactics.

Current surveillance technology allows for the geolocation of signals using frequency difference of arrival (FDoA) and time difference of arrival (TDoA) techniques. In a typical monitoring scenario, a hostile actor may utilize a multi-satellite configuration to target a specific signal of interest (SOI). A secondary monitoring satellite may capture the signal and transmit a timestamped snapshot to a primary satellite. The system then compares the timing and frequency differences between the two collection points to mathematically calculate the precise geographic location of the transmitter. This data is used to update location catalogs and record specific radio frequency (RF) characteristics, rendering the ground station vulnerable to physical compromise.

To counter these sophisticated monitoring techniques without disrupting legitimate operations, there is a growing need for advanced defensive strategies that transcend traditional hardware limitations. The industry is shifting toward virtualized architectures, where virtual network functions (VNFs) running on compute infrastructure replace static hardware components. These software-defined solutions allow for the precise orchestration of signal parameters, such as start times, stop times, and transmit power, across multiple distributed sites. This orchestration enables complex obfuscation techniques that prevent monitoring entities from isolating and geolocating a specific transmission source.

In accordance with some embodiments of the present disclosure, a method to avoid this geolocation technique involves transmitting similar signals from multiple locations surrounding the monitoring area. The objective is to manage multiple antenna sites using an orchestration tool that tightly controls the start time and power levels of signal generation. By the time the signals arrive at the monitoring satellite of interest, they are synchronized such that it is impossible to isolate any individual signal. The orchestration tool configures timing and power levels to ensure that, at the monitoring satellite, the generated signals appear simultaneously and with identical power levels.

To ensure that individual signals cannot be isolated by the monitoring site, the starting and stopping of each signal generator (sig-gen) are strictly controlled. The intent is that when the signals are received by the monitoring satellite and subsequently transmitted to the monitoring antenna site, they appear as a single composite signal. This requires each sig-gen to begin transmission at a precise time that accounts for the specific transmission delay to the intended monitoring satellite. Furthermore, each sig-gen should transmit at an appropriate power level to ensure all signals arrive at the monitoring satellite with equal power.

The delay for each sig-gen can be predicted based on the location of the monitoring satellite relative to the location of each sig-gen on Earth. Similarly, the required transmit power for each sig-gen is determined based on path loss, antenna gain, and other relevant parameters. Once the desired signal generation start time is calculated, the controller initiates a start command to all sig-gen sites with specific timing offsets to account for the propagation delay. After determining the start time, stop time, and transmit power, the controller communicates these parameters to each of the sig-gens, which then execute the commands accordingly.

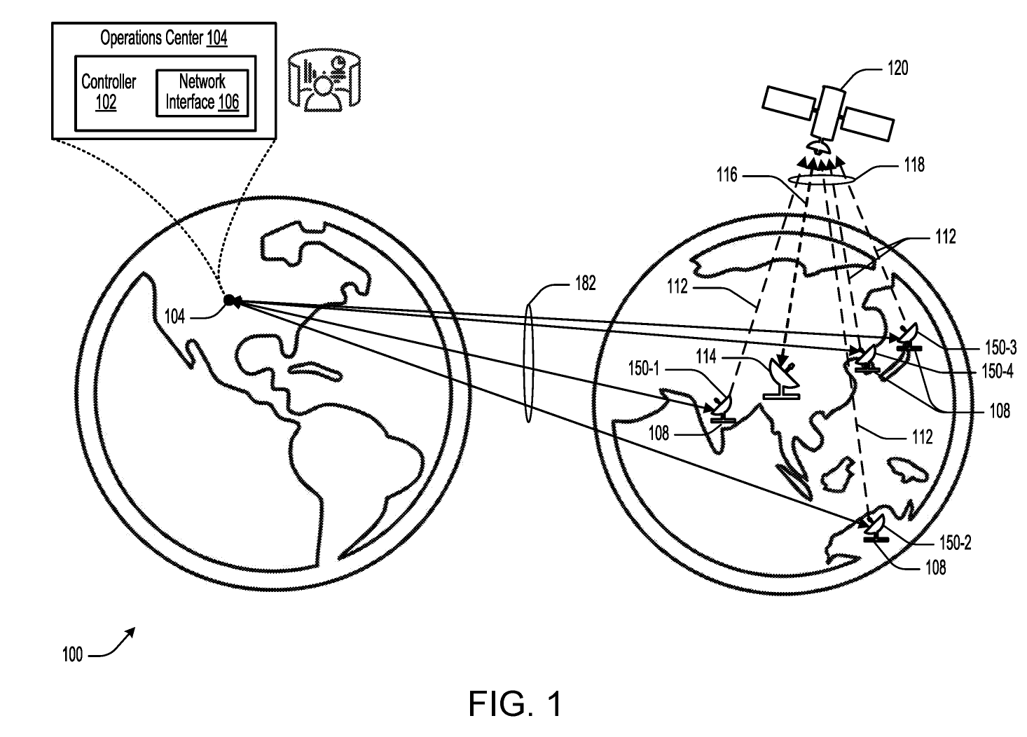

In some embodiments, each sig-gen site includes compute infrastructure running a sig-gen VNF. This VNF manages signal parameters and modifies the operation of the signal so that it is transmitted between the specified start and stop times at the specified power. The sig-gen may instantiate the VNF on the compute infrastructure upon receiving a command from the controller and deactivate or remove the VNF upon completion of the transmission. By controlling start times, stop times, and power levels in this manner, the system ensures the monitoring site cannot isolate individual signals, thereby defeating geolocation algorithms. FIG. 1 illustrates this system setup, showing a set of signal generators located at different positions surrounding the monitoring antenna. The locations of these signal generators are referred to as sig-gen sites, and each site includes at least one signal generation antenna used to transmit a signal over the monitoring link formed between the monitoring antenna and a monitoring satellite.

In the following description, various examples will be described. For purposes of explanation, specific configurations and details are set forth in order to provide a thorough understanding of the examples. However, it will also be apparent to one skilled in the art that the example may be practiced without the specific details. Furthermore, well-known features may be omitted or simplified in order not to obscure the embodiments being described.

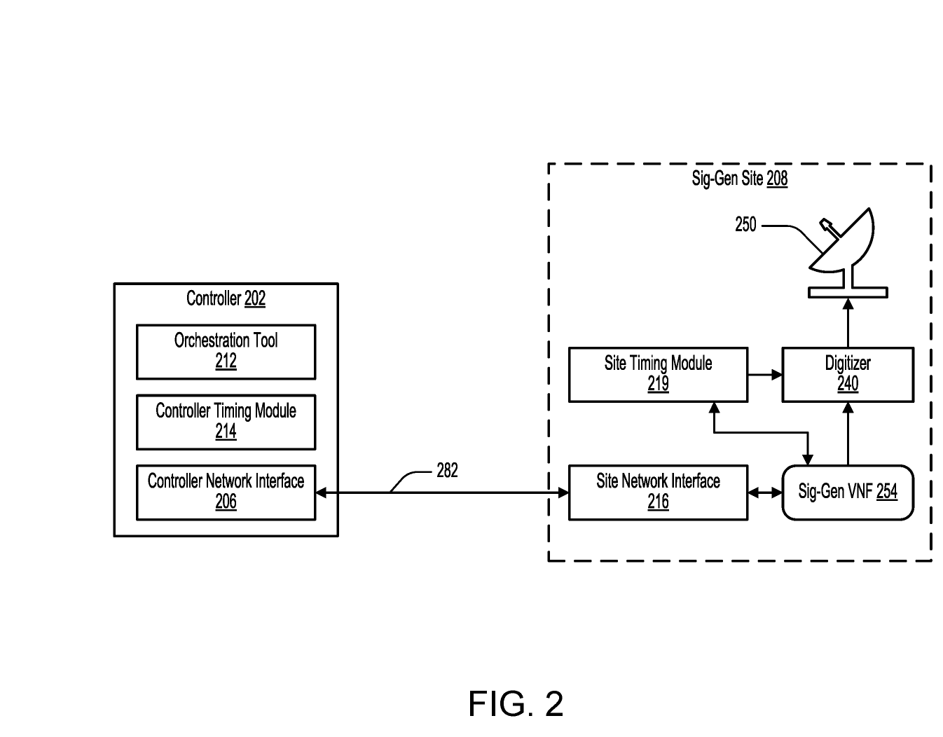

The figures herein follow a numbering convention in which the first digit or digits correspond to the figure number and the remaining digits identify an element or component in the figure. Similar elements or components between different figures may be identified by the use of similar digits. For example, 108 may reference element “08” in FIG. 1, and a similar element may be referenced as 208 in FIG. 2. As will be appreciated, elements shown in the various embodiments herein can be added, exchanged, and eliminated so as to provide a number of additional embodiments of the present disclosure. In addition, the proportion and the relative scale of the elements provided in the figures are intended to illustrate certain embodiments of the present disclosure and should not be taken in a limiting sense.

FIG. 1 illustrates a system 100 for avoiding geolocation, in accordance with some embodiments of the present disclosure. System 100 is designed to orchestrate signal transmissions to defeat surveillance techniques that rely on isolating a single signal source. System 100 may include an operations center 104, which may represent a physical facility, a command-and-control center, or a virtualized management environment. Operations center 104 houses a centralized controller 102, which serves as the primary orchestration engine for the system. Controller 102 is responsible for calculating the precise timing and power parameters required to obfuscate signal origins. Controller 102 includes a network interface 106 configured to facilitate external communications. Through network interface 106, controller 102 connects via a communication link 182 to a plurality of distributed assets. In various embodiments, communication link 182 may comprise a secure terrestrial network, a satellite backhaul link, a wide area network (WAN), or an encrypted tunnel over the Internet.

The distributed assets managed by controller 102 include a plurality of signal generator (sig-gen) sites 108 located at distinct geographic positions surrounding the area of interest. Each sig-gen site 108 is a facility or terminal equipped with the necessary hardware and software to generate and transmit RF signals. Specifically, each sig-gen site 108 includes one or more sig-gen antennas 150, such as a sig-gen antenna 150-1, 150-2, 150-3, or 150-4. These antennas are configured to transmit sig-gen signals 112 toward a specific target in orbit, identified here as a monitoring satellite 120. Also depicted is a monitoring antenna 114, which represents the victim or target terminal that system 104 seeks to protect or mimic. Monitoring antenna 114 targets monitoring satellite 120 via a monitoring link 116.

As the signals converge at the satellite, sig-gen signals 112 and the signal from monitoring link 116 form a combined signal path 118 at monitoring satellite 120. Controller 102 orchestrates the transmission of sig-gen signals 112 such that they arrive at monitoring satellite 120 substantially simultaneously with the signal from monitoring link 116. This precise arrival creates a combined signal along combined signal path 118 where the individual waveforms superimpose, preventing the isolation of individual signals necessary for geolocation algorithms to function effectively.

FIG. 2 illustrates detailed components of a controller 202 and a sig-gen site 208, in accordance with some embodiments of the present disclosure. Controller 202 functions as the centralized management node for the geolocation avoidance system and may comprise one or more processors configured to execute instructions. Controller 202 includes an orchestration tool 212, which serves as the logic engine for the system. Orchestration tool 212 is configured to ingest location data regarding the monitoring satellite, the monitoring antenna, and the dispersed signal generator sites. Based on this geometric data, orchestration tool 212 calculates the specific propagation delays and required path loss compensations for each site to determine the precise start times and transmit power levels necessary for simultaneous signal arrival.

To ensure these calculations can be executed with high precision across a distributed network, controller 202 utilizes a controller timing module 214. Controller timing module 214 maintains a highly accurate system time, potentially synchronized via GPS, Network Time Protocol (NTP), or Precision Time Protocol (PTP), serving as the master clock or synchronization reference for the orchestration commands. Commands generated by orchestration tool 212 are encapsulated and transmitted via a controller network interface 206. Controller network interface 206 handles the packetization and routing of these control messages over a communication link 282.

Sig-gen site 208 represents one of the multiple geographically dispersed transmission facilities managed by controller 202. Commands sent over communication link 282 are received by sig-gen site 208 via a site network interface 216. Site network interface 216 unpacks the network packets to extract the specific timing and power instructions targeted for that specific site. A site timing module 219 may maintain local time synchronization with controller timing module 214. Site timing module 219 ensures that the execution of start and stop commands occurs with microsecond or nanosecond precision relative to the global system time, regardless of network latency in communication link 282.

The core signal generation capability is provided by a signal generation virtual network function (sig-gen VNF) 254. Sig-gen VNF 254 is a software-defined component running on general-purpose compute infrastructure at sig-gen site 208. Upon receiving a command, sig-gen VNF 254 instantiates and generates the required digital waveform (e.g., noise, carrier tone, a modulated waveform containing dummy data or actual data, a comb sequence, or a chirp signal) at the specified power levels and duration. This digital stream (e.g., comprising digital IF packets) is passed to a digitizer 240. Digitizer 240 acts as a digital-to-analog converter (DAC) and upconverter, transforming the digital samples from sig-gen VNF 254 into an analog RF signal suitable for transmission. Finally, the analog RF signal is fed to a sig-gen antenna 250, which radiates the signal toward the monitoring satellite at the exact moment calculated by orchestration tool 212.

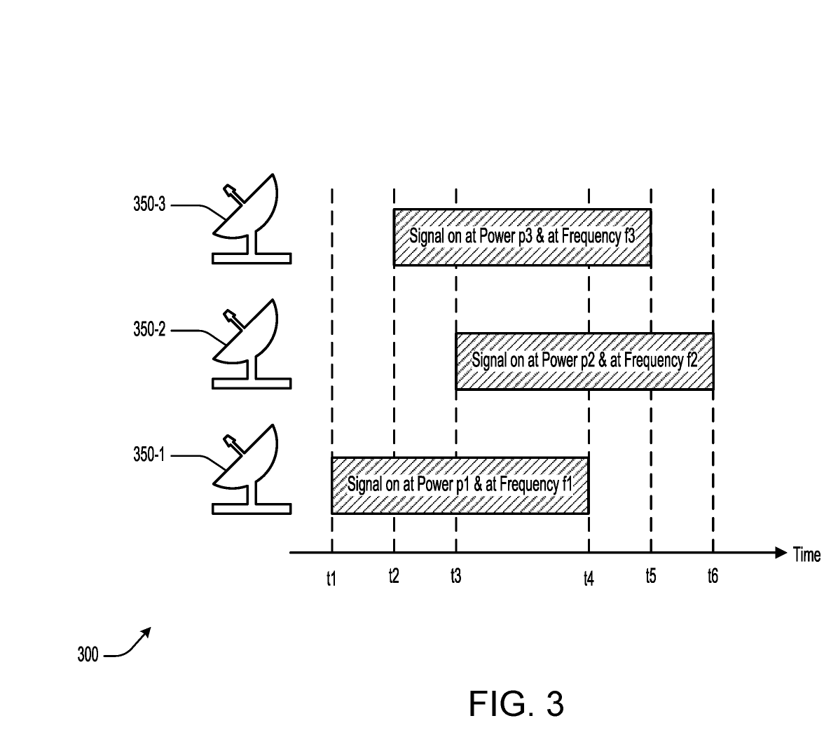

FIG. 3 illustrates a timing diagram 300 for orchestrated signal generation, in accordance with some embodiments of the present disclosure. Timing diagram 300 serves as a graphical representation of the temporal orchestration required to defeat TDoA geolocation techniques. The diagram plots the operational status of a plurality of antennas, specifically a sig-gen antenna 350-1, a sig-gen antenna 350-2, and a sig-gen antenna 350-3, against a horizontal time axis. These antennas represent geographically distinct transmission sites that must be tightly synchronized. Because each antenna is located at a different distance from the monitoring satellite, a signal transmitted from each site will take a different amount of time to travel through the atmosphere and space to reach the target.

To account for these variances in flight time, the controller calculates specific start times, denoted as a start time t1, a start time t2, and a start time t3. These start times are not simultaneous at the point of origin but are staggered offsets. As illustrated in the diagram, sig-gen antenna 350-1 is triggered to begin transmission at start time t1. In contrast, sig-gen antenna 350-3 waits to begin transmission until start time t2, and sig-gen antenna 350-2 begins transmission at start time t3. The shaded blocks extending to the right of these start times represent the duration of the “Signal On” state for each transmitter. For example, the signal from sig-gen antenna 350-1 remains active until a stop time t4, while the signal from sig-gen antenna 350-2 remains active until a stop time t6, and the signal from sig-gen antenna 350-3 remains active until a stop time t5. The duration of these pulses may be uniform or varied depending on the specific obfuscation strategy employed.

Furthermore, timing diagram 300 details the specific signal parameters assigned to each transmitter to ensure indistinguishability at the target. Just as propagation delay varies by location, path loss (signal attenuation) also varies. To compensate, each antenna is assigned a specific transmit power level, shown as a power p1, a power p2, and a power p3. For instance, sig-gen antenna 350-1 transmits at power p1, while sig-gen antenna 350-2 transmits at power p2. These power levels are calculated so that, despite traveling different distances and through different atmospheric conditions, the signals arrive at the satellite with substantially identical signal strengths. Finally, the diagram indicates the frequency assignments, denoted as a frequency f1, a frequency f2, and a frequency f3. In a preferred embodiment for geolocation avoidance, frequencies f1, f2, and f3 are identical or substantially similar, occupying the same bandwidth to create a composite, confused signal at the monitoring satellite.

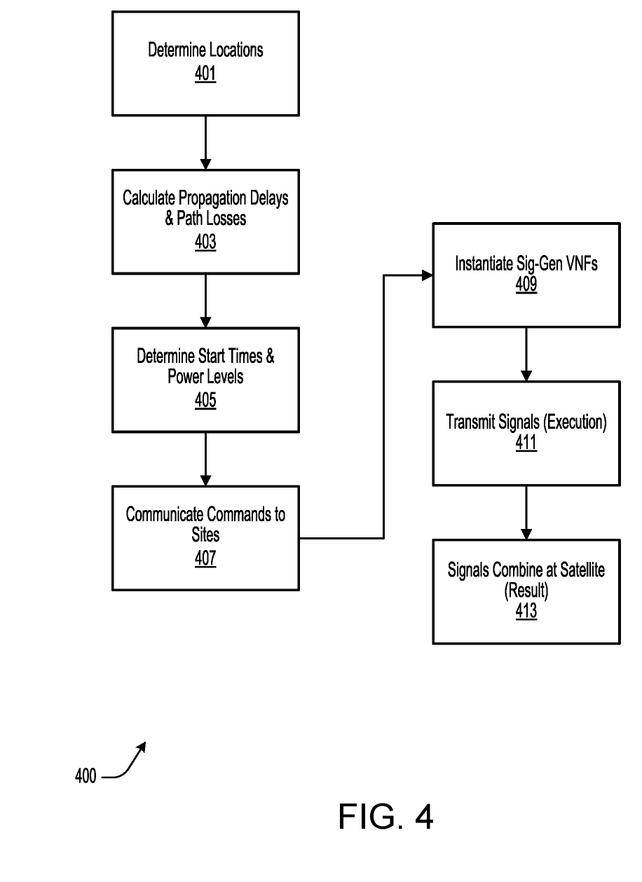

FIG. 4 illustrates a flowchart of a method 400 for orchestrating signal transmissions, in accordance with some embodiments of the present disclosure. Method 400 begins at step 401, labeled “Determine Locations”. In this initial phase, the orchestration system ingests necessary geometric and orbital data. This includes determining the precise orbital position (ephemeris) of the monitoring satellite at the specific time of interest. Simultaneously, the system identifies the active geographic coordinates (latitude, longitude, and altitude) of the available signal generator sites. This spatial awareness establishes the baseline geometry needed for all subsequent timing calculations.

Following the location determination, method 400 proceeds to step 403, labeled “Calculate Propagation Delays & Path Losses”. Here, the system performs physics-based calculations for each individual link between a signal generator site and the monitoring satellite. The propagation delay is derived by dividing the slant range distance by the speed of light, resulting in a precise time-of-flight value for each site. Concurrently, the system calculates the free-space path loss and atmospheric attenuation expected for each link. These calculations quantify how much the signal will degrade over distance, which may be used for ensuring power equalization at the target.

Based on the calculated delays and losses, the process moves to step 405, labeled “Determine Start Times & Power Levels”. This step represents the core orchestration logic. To ensure simultaneous arrival, the system defines a target arrival time at the satellite and then subtracts the specific propagation delay for each site to yield a unique start time for that site. Similarly, the system inverts the path loss differences to assign a transmit power level to each site. Sites further away or with higher attenuation are commanded to transmit at higher power levels so that all signals arrive at the satellite with substantially identical strength.

Once the parameters are finalized, the method advances to step 407, labeled “Communicate Commands to Sites”. The controller packetizes the calculated start times, durations, and power levels into control messages. These messages are transmitted over a network communication link to the distributed signal generator sites. This step relies on network synchronization protocols to ensure that the timestamps contained within the commands are interpreted accurately by the remote hardware relative to a common system time.

Upon receipt of the commands, the process at the remote sites enters step 409, labeled “Instantiate Sig-Gen VNFs”. Rather than relying on static hardware, the sites utilize general-purpose compute infrastructure to spin up signal generator VNFs. These software-defined appliances are configured dynamically with the parameters received in the command, preparing the digital waveform (e.g., noise, carrier tone, or modulated waveform) for generation. This virtualization allows for rapid scaling and reconfiguration of the signal properties.

At the designated start time, method 400 proceeds to step 411, labeled “Transmit Signals (Execution)”. The instantiated VNFs generate the digital streams, which are converted to analog RF signals by digitizers and radiated by the antennas. This execution is strictly timed according to the instructions from step 405. Notably, because of the staggered start times calculated earlier, the sites do not transmit simultaneously but at precise offsets that compensate for their differing distances to the target.

Finally, the method culminates in step 413, labeled “Signals Combine at Satellite (Result)”. This step describes the physical effect achieved in the space segment. Because the transmission times were offset to account for propagation delays, and power levels were adjusted for path loss, the independent signals arrive at the monitoring satellite’s receiver at the exact same instant and with the same amplitude. This results in a composite signal where the individual sources are indistinguishable, thereby defeating TDoA and FDoA geolocation attempts.

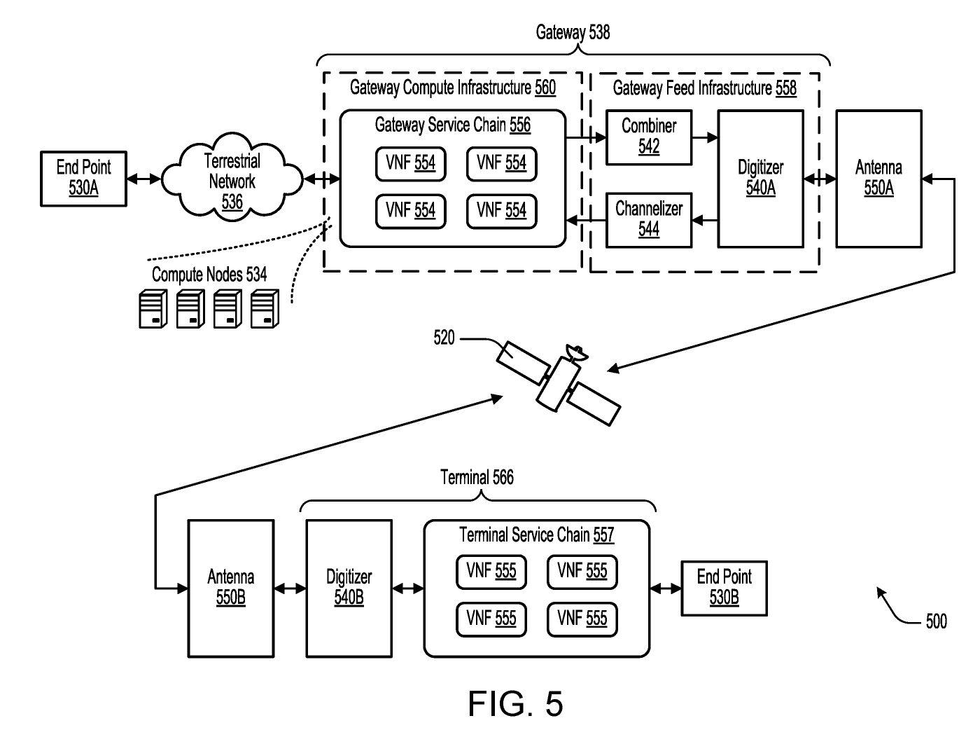

FIG. 5 illustrates an example communication path between an end point 530A and an end point 530B enabled by a satellite communication system 500, in accordance with some embodiments of the present disclosure. In the illustrated example, satellite communication system 500 includes a gateway 538 in communication with a terminal 566 via a satellite 520. In various examples, satellite 520 may send and receive wireless signals within one or more bands of a number of possible frequency bands between approximately 0.9-300 GHz including, for example, L Band (1-2 GHz), S-Band (2-4 GHz), C-Band (4-8 GHz), X-Band (8-12 GHz), Ku-Band (12-18 GHz), Ka-Band (26.5-40 GHz), and V-Band (40-75 GHz).

In various examples, end points 530 may correspond to portable mobile devices, internet of things (IoT) devices, desktop computers, user terminals, or any of a number of devices with communication capabilities. Alternatively, end points 530 may correspond to networks such as mobile towers, mining sites, ships, planes, or the like. In one example, end point 530A may correspond to a service and end point 530B may correspond to a consumer. It should be understood that the satellite communication environment may comprise other end points 530 and/or other arrangements of components than those illustrated. Furthermore, multiple communication paths may be constructed and operated in parallel, and separate communication paths may have different arrangements from each other.

End point 530A may be communicatively connected via a terrestrial network 536 (e.g., comprising the Internet, a private telecom backbone, or a cloud compute center) to a gateway 538. Gateway 538 may include one or more switches (not shown) to facilitate communication between the various components, such as a first switch at the boundary between terrestrial network 536 and a gateway compute infrastructure 560, and a second switch at the boundary between gateway compute infrastructure 560 and a gateway feed infrastructure 558. Such switches may be physical or virtual Gigabit Ethernet (GigE) switches. However, it should be understood that the above-described first and second switches could be implemented in the same switch. In some examples, the first switch may implement transport from terrestrial network 536 to a VNF 554 within a gateway service chain 556. In such a case, VNF 554 may act as a User Network Interface (UNI) or an External Network-Network Interface (ENNI) as defined by the applicable MEF Ethernet services and MEF operator services standards. Alternatively, the first switch may itself represent the UNI as defined by the applicable MEF standards.

Gateway compute infrastructure 560 may include a set of compute nodes 534 situated onsite (at a same physical location) or offsite (at a different physical location) relative to antenna 550. In some examples, compute nodes 534 may comprise general-purpose computers or servers capable of running VNFs 554 (e.g., as workloads) and other virtualization software such as hypervisors to support gateway service chain 556. In some examples, compute nodes 534 may employ x86 architectures, ARM architectures, RISC-V architectures, among other possibilities. Compute nodes 534 may be configured as clusters, data centers, warehouse-scale computers, among other possibilities. Gateway compute infrastructure 560 may further include suitable storage systems that provide persistent and reliable storage in support of VNFs 554.

In some examples, gateway compute infrastructure 560 may include a managing system that instantiates and configures one or more VNFs 554 to form gateway service chain 556. Two sets of one or more VNFs 554 may provide two-way communication, including a transmission path and a reception path, between terrestrial network 536 and a gateway feed infrastructure 558 of gateway 556. It should be understood that in an example in which gateway service chain 556 provides only one-way communication, VNFs 554 may provide only a transmission path without providing a reception path. The set of VNFs 554 (e.g., implementing a gateway) on the forward path towards the link to satellite 520, may comprise or constitute a traffic handler, an encapsulator (e.g., implementing generic stream encapsulation (GSE)), a modulator (e.g., the OpenSpace™ Wideband Software modulator, offered by Kratos Defense & Security Solutions, Inc. of San Diego, California), a combiner, an encryption/decryption VNF, a time division multiple access (TDMA) resource allocator, an antenna controller, among other possibilities.

This set of VNFs 554 on the transmission path may convert protocol data units (PDUs) into a digital signal (such as a digital intermediate frequency (IF) waveform or a composite digital IF waveform). For example, the traffic handler may process data link layer (e.g., Layer 2 or L2 in the Open Systems Interconnection (OSI) model) and/or network layer (e.g., Layer 3 or L3 in the OSI model) traffic, and provide the processed Ethernet frames or IP packets to the encapsulator. The encapsulator may convert the PDUs into baseband frames, and provide the baseband frames to the modulator. A baseband frame may be the basic unit of transmission in satellite communication system 500. The encapsulator may form baseband frames in accordance with the 5G standard, the DVB-S2X standard, described in European Telecommunications Standards Institute (ETSI) European Standard (EN) 302 307-1 v1.4.1 (2014-11), among other possible standards. The encapsulator may comprise one or more VNFs 554 (or software subprocesses) that perform one or more of the following functions: frame chopping, forward modulation selection (e.g., with Adaptive Coding and Modulation (ACM)), Ethernet bridge (e.g., Media Access Control (MAC) table, smart bridging/learning/relay, etc.), Address Resolution Protocol (ARP) (e.g., Ethernet MAC discovery), VLAN manipulation (e.g., to rewrite Ethernet frames on ingress/egress based on the MEF service definition), header compression (e.g., Robust Header Compression (ROHC)); and/or OTA optimization (e.g., Space Communications Protocol Specifications (SCPS)/TCP-Acceleration). The modulator may convert the baseband frames into signal data packets in accordance with a particular standard, including the standards of the Digital Intermediate Frequency Interoperability (DIFI) Consortium in the DIFI/Institute of Electrical and Electronics Engineers (IEEE) 1.0 specification, the VMEbus International Trade Association (VITA) standard, the enhanced Common Public Radio Interface (eCPRI) standard, among other possibilities. In an embodiment, the encapsulator and the traffic handler may be implemented as a single VNF 554, referred to as a virtualized traffic adaptor (vModem). The VNF-implemented combiner or a combiner 542 (implemented in hardware) may combine the signal data packets into a digital signal and provide the digital signal to a digitizer 540A, which may convert the digital signal into an analog signal.

The set of VNFs 554 on the return path may comprise or constitute, in order, a digital channelizer (e.g., the OpenSpace™ Wideband Channelizer, offered by Kratos Defense & Security Solutions, Inc. of San Diego, California), a demodulator (e.g., the OpenSpace™ Wideband Software Receiver, offered by Kratos Defense & Security Solutions, Inc. of San Diego, California), and a decapsulator. This set of VNFs 554 on the reception path may convert a digital signal (such as a digital IF waveform or a composite digital IF waveform) to PDUs, which may be Ethernet frames or IP packets, among other possibilities. For example, the VNF-implemented channelizer or a channelizer 544 (implemented in hardware) may receive a digital signal from digitizer 540A, which has converted an analog signal into the digital signal, and divide the digital signal into signal data packets. The demodulator may convert the signal data packets to baseband frames, and provide the baseband frames to the decapsulator. The decapsulator may convert the baseband frames into PDUs, which may be transmitted, via terrestrial network 536, to end point 530A. It should be understood that the demodulator performs the reverse function(s) of the modulator, and the decapsulator performs the reverse function(s) of the encapsulator. In an embodiment, the decapsulator and demodulator may be implemented as a single VNF 554, for example, together with the traffic handler, encapsulator, and modulator, in a vModem. In other words, a vModem may consist of a single VNF 554 that implements all of the functions of the traffic handler, encapsulator/decapsulator, and modulator/demodulator.

In some embodiments, in which gateway service chain 556 implements a vModem, the vModem may comprise one or more modulators that are configured to modulate waveforms according to a digital satellite broadcast standard and/or one or more demodulators that are configured to demodulate waveforms according to a digital satellite broadcast standard. Such a vModem may provide carrier ethernet (CE) services, in which case the vModem may comprise one or more encapsulators that convert Ethernet frames into baseband frames that are modulated into waveforms by the modulator(s), and one or more decapsulators that convert baseband frames, which have been demodulated from waveforms by the demodulator(s), into Ethernet frames. The digital satellite broadcast standard may be a digital satellite television broadcast standard, such as the DVB-S2X standard managed by the Digital Video Broadcasting (DVB) Project. While a digital satellite broadcast standard, such as a DVB standard, is used as an example, the vModem may be configured to modulate and demodulate waveforms according to other standards for wideband digital communication, such as orthogonal frequency-division multiplexing (OFDM), or the like.

The digital signal from combiner 542 is transmitted to digitizer 540A, which converts the digital signal output by combiner 542 into an analog transmission signal for communication to satellite 520. Digitizer 540A further digitizes analog reception signals from satellite 520 into digital signals for use by channelizer 544. In some examples, digitizer 540A may be software-defined. As one example, digitizer 540A may be a SpectralNet™, which is a carrier-grade RF digitizer, offered by Kratos Defense & Security Solutions, Inc. of San Diego, California. Digitizer 540A communicates with antenna 550A. In particular, digitizer 540A provides the transmission signal to antenna 550A, which transmits the transmission signal to satellite 520. In addition, in two-way communications, antenna 550A receives a reception signal from satellite 520, and provides the reception signal to digitizer 540A.

In various examples, antenna 550A may be a parabolic reflector antenna, a flat panel antenna, a phased array antenna, a helical antenna, a patch antenna, a horn antenna, among other possibilities. In some examples, antenna 550A may be an electronically steered antenna that can use electronic means to control the direction and shape of its radiation pattern. Such an antenna can generate multiple beams simultaneously, allowing it to transmit or receive signals in multiple directions at the same time. Antenna 550A may include both the physical antenna as well as the corresponding radio frequency (RF) subsystem, which may include a combination of diplexers, amplifiers (e.g., low noise amplifiers (LNAs)), upconverters, and downconverters (e.g., low-noise block downconverters (LNBs) depending on the specific frequency band and application.

Satellite 520 relays wireless signals from antenna 550A to antenna 550B. In two-way communications, satellite 520 also relays wireless signals from antenna 550B to antenna 550A. Antenna 550B may be functionally similar or identical to antenna 550A, and therefore, any description of antenna 550A applies equally to antenna 550B, which may not be redundantly described herein. Similarly, digitizer 540B may be functionally similar or identical to digitizer 540A, and therefore, any description of digitizer 540A applies equally to digitizer 540B, which may not be redundantly described herein.

Digitizer 540B may communicate directly with a terminal service chain 557 of a terminal compute infrastructure. Terminal service chain 557 may comprise a set of VNF(s) 555 forming a reception path from digitizer 540B to end point 530B. In two-way communications, terminal service chain 557 may also comprise a set of VNFs 555 forming a transmission path from end point 530B to digitizer 540B. The reception and transmission paths may be identical or similar to the reception and transmission paths described with respect to gateway service chain 556. For example, the reception path may comprise a demodulator followed by a decapsulator to convert signal frames into PDUs, and the transmission path may comprise an encapsulator followed by a modulator to convert PDUs into signal frames. The traffic handler, encapsulator, decapsulator, modulator, and demodulator may all be similar or identical to those described with respect to gateway service chain 556, and therefore, the descriptions of those components with respect to gateway service chain 556 apply equally to those components in terminal service chain 557.

Terminal service chain 557 may communicate with end point 530B. For example, the traffic handler of terminal service chain 557 may transmit Ethernet frames to end point 530B. In addition, in two-way communications, the encapsulator of terminal service chain 557 may receive PDUs from end point 530B. Thus, the combination of gateway service chain 556 and terminal service chain 557 enable one-way or two-way communications between end points 530A and 530B over a satellite link.

Gateway service chain 556 and terminal service chain 557 may comprise one or more of the software-defined components (e.g., VNFs and/or digitizers) described in International Patent App. Nos. PCT/US2021/033867, filed on May 24, 2021, PCT/US2021/033875, filed on May 24, 2021, PCT/US2021/033905, filed on May 24, 2021, and PCT/US2021/062689, filed on Dec. 9, 2021, which are all hereby incorporated herein by reference as if set forth in full.

Advantageously, the utilization of VNFs and software-defined components (e.g., digitizers 540A and 540B) to perform various functions, aid in automation and scalability. Embodiments may minimize the presence of physical hardware components, such that satellite communication system 500 can be dynamically reconfigured (e.g., added, updated, destroyed, increased or decreased in dimension, etc.) in real time, primarily using in-band network communications, to adapt to the unique multivariate satcom environment (e.g., changing traffic patterns, RF interference, atmospheric characteristics, antenna conditions, path length, etc.).

Notably, dynamic reconfiguration of VNFs in a cloud computing environment can be used, not only to increase the dimensions of the computing resources (e.g., number of vCPUs, amount of memory and/or disk storage, network throughput, etc.) used for satellite communication system 500 on demand to ensure the sufficiency of the satellite communication system, but also to decrease the dimensions of the computing resources on demand to optimize the utilization of the hardware. For example, favorable changes in the satcom environment may improve performance of satellite communication system 500, such that satellite communication system 500 is providing significantly better performance than is required by the service level agreement. In this case, the management system may determine that gateway service chain 556 and terminal service chain 557 are insufficient, and update the service chains to reduce the resources used in the service chains (e.g., by reducing RF bandwidth usage, resizing one or more VNFs, swapping to a service chain with reduced dimensions, etc.). This is in contrast to conventional hardware-based service chains in which unused resources would simply be idled or otherwise ignored, representing a sunk cost that cannot be recouped.

In the context of the geolocation avoidance system 100 (FIG. 1), sig-gen site 108 may be implemented using the hardware and software architecture of terminal 566 or gateway 538. For example, compute nodes 534 may execute sig-gen VNF 254 (FIG. 2) instead of, or in addition to, the standard gateway service chain 556. Similarly, antenna 550A/B may correspond to sig-gen antenna 150 used to transmit the obfuscation signals.

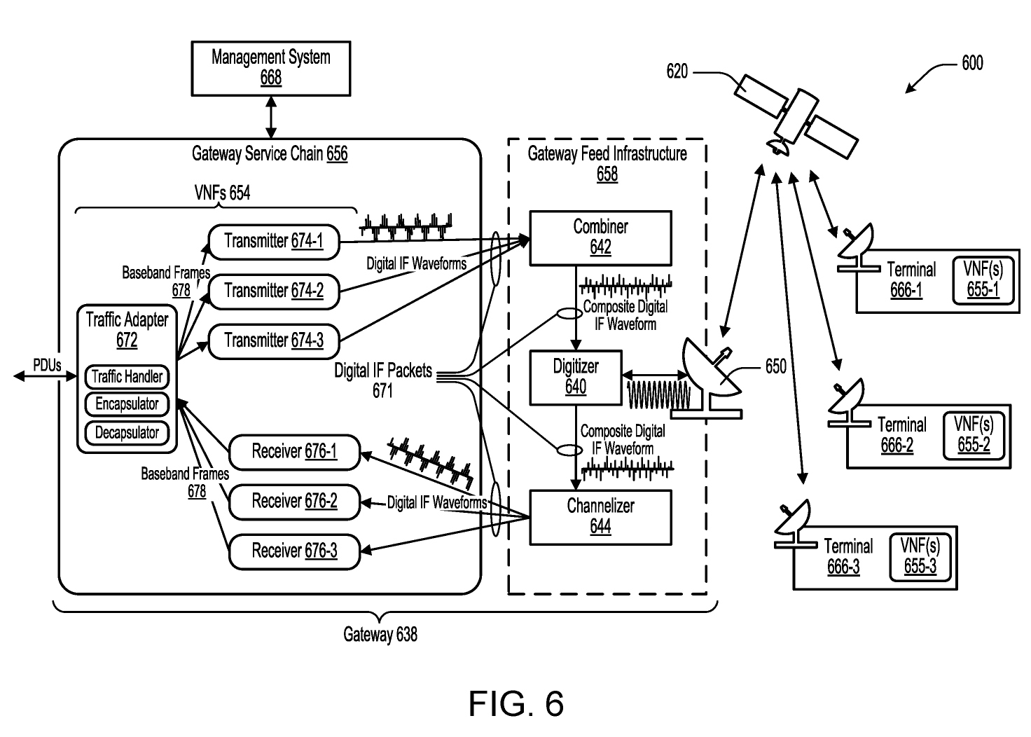

FIG. 6 illustrates an example satellite communication system 600 including a gateway 638 and a set of terminals 666 (or “remote terminals”), in accordance with some embodiments of the present disclosure. In the illustrated example, satellite communication system 600 includes a gateway 638 (or “hub”) in communication with each of terminals 666 via a satellite 620. Gateway 638 may include a gateway feed infrastructure 658 that serves as an onsite infrastructure (close to antenna 650, e.g., at a same physical location) that may perform primarily signal digitization and signal routing-related tasks and a gateway compute infrastructure that can be onsite or offsite infrastructure (far from antenna 650, e.g., at a different physical location) that supports a gateway service chain 656 that performs primarily signal processing and packet processing-related tasks. The gateway compute infrastructure may include one or more computers, clusters, a data center, or a warehouse-scale computer. The compute nodes comprising the gateway compute infrastructure and/or gateway feed infrastructure 658 may include general-purpose computers or servers employing x86 architectures, ARM architectures, RISC-V architectures, among other possibilities.

Gateway 638 may include a gateway service chain 656 comprising a set of VNFs 654 running on the gateway compute infrastructure. Examples of VNFs 654 include one or more traffic adapters 672, one or more virtual transmitters 674, one or more virtual receivers 676, among other possibilities. Each of VNFs 654 may be instantiated and configured by a management system 668 that scales up or down the number of active VNFs based on the number of active terminals 666. Management system 668 may further configure VNFs 654 such that satellite communication system 600 implements any one of a number of network topologies, including a single channel per carrier (SCPC) network, a TDMA network, a frequency division multiple access (FDMA) network, a mesh network, among other possibilities.

Traffic adapter 672 acts as the bridge between the terrestrial network and the satellite network. In some examples, traffic adapter 672 may include a traffic handler that processes data link layer (e.g., Layer 2 in the OSI model) and/or network layer (e.g., Layer 3 in the OSI model) traffic and provides the processed PDUs to the encapsulator, which convert the PDUs into baseband frames 678 and provides baseband frames 678 to one of virtual transmitters 674. On the reception path, baseband frames 678 produced by virtual receivers 676 are received by the decapsulator of traffic adapter 672. The decapsulator may convert baseband frames 678 into Ethernet frames and pass the Ethernet frames to the traffic handler, which processes and provides the Ethernet frames to a terrestrial network.

Virtual transmitters 674 provide transmission paths between a terrestrial network and a gateway feed infrastructure 658 of gateway 638. Each of virtual transmitters 674 on a transmission path may comprise or constitute a forward error correction (FEC) encoder that adds redundant bits according to a particular error-correcting code and a modulator (e.g., the OpenSpace™ Wideband Software modulator) that converts incoming baseband frames 678 into digital IF packets 671 containing digital waveforms at IF or RF frequencies (or “digital IF waveforms”). Each of virtual transmitters 674 may implement a modulator that converts baseband frames 678 into digital IF packets 671 (e.g., according to the standards of the DIFI Consortium in the DIFI/IEEE 1.2 specification) to create the digital IF waveforms.

Digital IF packets 671 generated by virtual transmitters 674 may be fed into a combiner 642 that combines the multiple digital IF waveforms into a single composite signal (or “composite digital IF waveform”). Digital IF packets 671 containing the composite digital IF waveform is fed into a digitizer 640 that converts the digital signal into an analog signal in preparation for wireless transmission via an antenna 650. While combiner 642 is illustrated in FIG. 6 as being an element of gateway feed infrastructure 658, it is to be understood that a combiner VNF (or multiple combiner VNFs) may be instantiated by management system 668 to perform similar functionality.

On the reception path, digitizer 640 digitizes analog signals received from satellite 620 to generate digital IF packets 671 containing digital IF waveforms (e.g., a composite digital IF waveform) of the received analog signals for use by a channelizer 644. The composite digital IF waveform received by channelizer 644 may be a wide-band spectrum (e.g., 100 MHz, 500 MHz, 3 GHz, etc.) that may contain several signals within that segment of the frequency band. In some instances, channelizer 644 divides the composite digital IF waveform into separate digital IF waveforms and sends the waveforms (in the form of digital IF packets 671) to appropriate virtual receivers 676. While channelizer 644 is illustrated in FIG. 6 as being an element of gateway feed infrastructure 658, it is to be understood that a channelizer VNF (or multiple channelizer VNFs) may be instantiated by management system 668 to perform similar functionality.

Virtual receivers 676 provide reception paths between gateway feed infrastructure 658 and a terrestrial network. Each of the set of virtual receivers 676 on a reception path may comprise or constitute a demodulator (e.g., the OpenSpace™ Wideband Software Receiver) that converts incoming digital IF packets 671 containing digital IF waveforms into baseband frames 678 and an FEC decoder that receives the output of the demodulator and uses the redundant bits added by the FEC encoder to identify and correct any errors introduced during transmission. Baseband frames 678 produced by virtual receivers 676 are sent to the decapsulator of traffic adapter 672, which are then converted into Ethernet frames that are passed by the traffic handler to a terrestrial network.

Satellite 620 relays wireless signals from antenna 650 to the antennas of terminals 666, or vice versa. In two-way communications, satellite 620 also relays wireless signals from the antennas of terminals 666 to antenna 650. In some examples, each of terminals 666 may include hardware infrastructure to support one or more VNFs 655. In some examples, VNFs 655 at each of terminals 666 may implement a vModem that comprises one or more modulators that are configured to modulate waveforms according to a digital satellite broadcast standard and/or one or more demodulators that are configured to demodulate waveforms according to the digital satellite broadcast standard. Such a vModem may provide CE services, in which case the vModem may comprise one or more encapsulators that convert Ethernet frames into baseband frames that are modulated into waveforms by the modulator(s), and one or more decapsulators that convert baseband frames, which have been demodulated from waveforms by the demodulator(s), into Ethernet frames, together with a traffic handler that connects the encapsulators and decapsulators with the terrestrial networks connected to terminals 666.

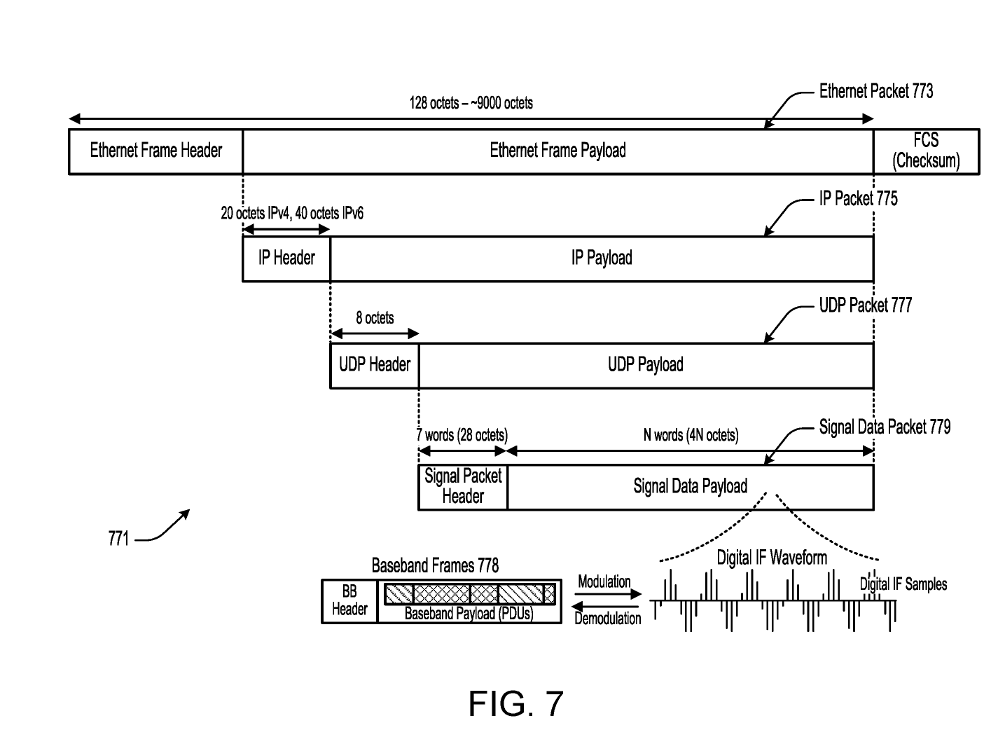

FIG. 7 illustrates an example digital IF packet 771 with multiple protocol layers, in accordance with some embodiments of the present disclosure. In the illustrated example, digital IF packet 771 includes a digital IF waveform contained within the signal data payload of a signal data packet 779. The digital IF waveform may represent the modulated form of one or more baseband frames 778 (or portions of one or more baseband frames 778), such that the baseband frames may be recovered by demodulating the digital IF waveform contained within the signal data payload. Signal data packet 779 may also include a signal packet header, which may implement the VITA standard (e.g., VITA 49.2 specification) or another standard.

In some examples, signal data packet 779 is encapsulated within a UDP packet 777 having a UDP header and UDP payload. UDP packet 777 may be encapsulated within an IP packet 775 having an IP header and IP payload, which may be encapsulated within an Ethernet packet 773 having an Ethernet frame header and Ethernet frame payload. In some examples, the total Ethernet packet size varies based on the number and size of the data samples in the signal data payload of signal data packet 779. There may be a fixed overhead within the Ethernet frame which comprises the IP header (20 octets for IPv4 or 40 octets (minimum) for IPv6), the UDP header (8 octets), the signal packet header (28 octets). In some examples, the Ethernet frame payload is adjustable from 128 octets to approximately 9000 octets.

In some examples, digital IF packet 771 may include different packet classes for signal data packet 779. In a first packet class, signal data packet 779 may be a regular data packet that includes the data for the digital samples forming the digital IF waveform. In a second packet class, signal data packet 779 may be a context packet that includes data to ensure standardization of the transport of metadata describing the sampled signal data. Such data may include the IF reference frequency, the sample rate, the bit depth, the equivalent analog bandwidth of the signal represented by the digital stream, the frequency offset of the center of the band occupied by the signal from the IF reference frequency, among other possibilities. In a third packet class, signal data packet 779 may be a command packet that includes data used to provide and acknowledge device settings and support control of timing to permit synchronization of upstream or downstream devices.

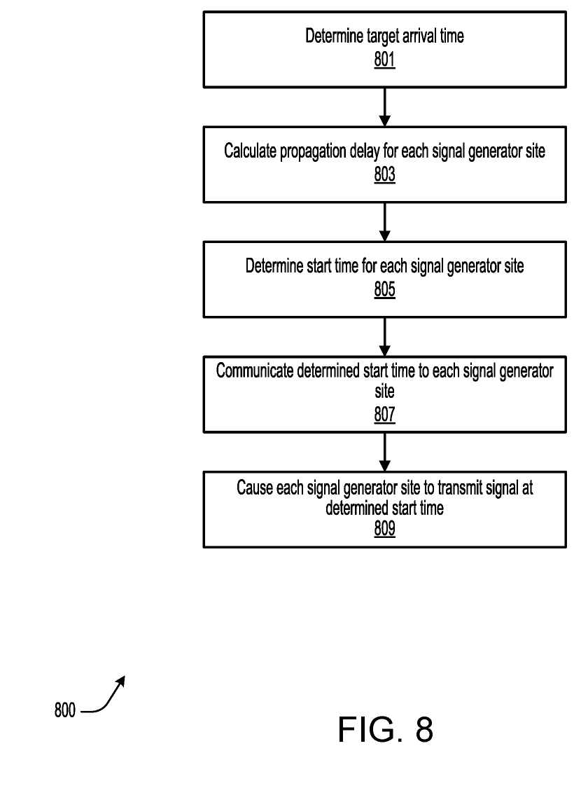

FIG. 8 illustrates an example method 800 of orchestrating radio frequency transmissions directed toward a monitoring satellite, in accordance with some embodiments of the present disclosure. Steps of method 800 may be performed in any order and/or in parallel, and one or more steps of method 800 may be optionally performed. One or more steps of method 800 may be performed by one or more processors (e.g., processors 904). Method 800 may be implemented as a computer-readable medium (e.g., memory devices 912) or computer program product comprising instructions (e.g., instructions 916) which, when the program is executed by one or more processors, cause the one or more processors to carry out the steps of method 800.

At step 801, a target arrival time is determined by a controller (e.g., controller 102, 202). The target arrival time corresponds to a specific moment at which signals are intended to arrive at a monitoring satellite (e.g., monitoring satellite 120, 520, 620). In various embodiments, this determination may be based on a scheduled surveillance window during which the satellite is overhead, or it may be triggered by the detection of a specific threat. For example, the controller may determine the target arrival time to coincide with a scheduled data burst from a high-value asset, ensuring that the obfuscating signals mask the asset’s transmission. In another example, the target arrival time may be calculated continuously in real-time as the satellite moves through its orbital arc.

At step 803, propagation delay is calculated by the controller for each of a plurality of signal generator sites (e.g., sig-gen sites 108, 208). The plurality of sig-gen sites are distributed at distinct geographic locations. Calculating the propagation delay may involve orbital mechanics calculations. For instance, the controller may utilize Two-Line Element (TLE) sets or high-precision ephemeris data to determine the instantaneous position of the monitoring satellite. By computing the slant range (straight-line distance) between the GPS coordinates of each sig-gen site and the satellite’s position, and dividing this distance by the speed of light, the controller derives the time-of-flight for the signal. This calculation may also account for atmospheric refraction or other propagation anomalies to enhance precision.

At step 805, a start time is determined by the controller for each of the plurality of signal generator sites based on the target arrival time and the calculated propagation delay. The start time is calculated such that signals transmitted by the plurality of sig-gen sites arrive at the monitoring satellite substantially simultaneously. This step effectively synchronizes the arrival times despite the disparate travel times. For example, if Site A has a propagation delay of 250 milliseconds and Site B has a delay of 240 milliseconds, the controller will command Site B to wait 10 milliseconds after Site A begins transmitting (or calculate absolute start times that reflect this offset). The start times may be determined with microsecond or nanosecond precision to ensure constructive or destructive interference at the target.

In this context, “substantially simultaneously” means that the arrival times of the leading edges of the signals at the monitoring satellite differ by no more than a predetermined threshold. In various embodiments, this threshold may be less than 1 second, less than 100 milliseconds, less than 10 milliseconds, less than 1 millisecond, less than 100 microseconds, less than 10 microseconds, less than 1 microsecond, or less than 100 nanoseconds, among other possibilities.

At step 807, the determined start time is communicated by the controller to each of the plurality of signal generator sites via a communication link (e.g., communication link 182, 282). Communicating the start time typically involves encapsulating the command in a network packet (e.g., IP, UDP, or TCP) transmitted over a terrestrial or satellite network (e.g., terrestrial network 536). The communication may utilize standard time synchronization protocols such as PTP or NTP to ensure that the recipient sites interpret the start time timestamp relative to a unified system clock. In some examples, the communication may also include the duration of the transmission, the center frequency, and the modulation type.

At step 809, each of the plurality of signal generator sites is caused to transmit a signal at the determined start time. This step involves the physical execution of the command. In preferred embodiments, this comprises instantiating a VNF (e.g., VNF 254, 554, 654) on a general-purpose compute node (e.g., compute node 534) at the site. The VNF generates a digital waveform which is then processed by a digitizer (e.g., digitizer 240, 540, 640) to convert it to an analog signal. Finally, the signal is radiated via an antenna (e.g., antenna 150, 250, 350, 550, 650). By using VNFs, the system can dynamically change the signal characteristics (e.g., switching from noise to a carrier tone) without changing hardware.

Method 800 may include additional steps or variations. For instance, the method may further include calculating a path loss (signal attenuation) from each site to the satellite and determining a transmit power level for each site based on this calculation. The controller then communicates this power level to the sites, ensuring that all signals arrive at the satellite with substantially identical power levels, preventing the monitoring system from locking onto the “loudest” signal.

Additionally, method 800 may involve specific lifecycle management of the signal generation software. This includes instantiating a signal generator VNF on the compute infrastructure prior to transmission and deactivating or removing the VNF upon completion to free up computing resources. Regarding signal characteristics, the transmitted signals may comprise a noise source, a continuous wave carrier tone, or a modulated waveform containing dummy data. Notably, the signals may overlap in time and frequency but do not require strict phase coherence, nor do they require successful data demodulation by the receiver. Finally, to maintain effectiveness against moving targets, the method may include dynamically updating the start times based on the changing orbital position of the monitoring satellite. The ultimate result of these steps is the creation of a combined signal at the satellite that prevents isolation of any single site by TDoA or FDoA techniques.

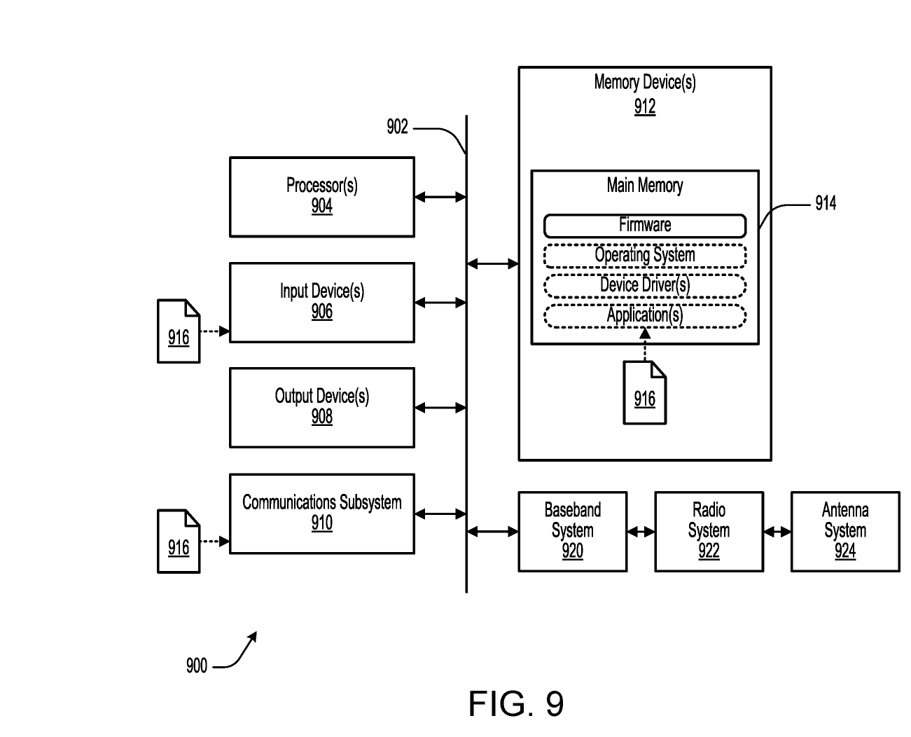

FIG. 9 illustrates an example computer system 900 comprising various hardware elements, in accordance with some embodiments of the present disclosure. Computer system 900 may be incorporated into or integrated with devices described herein and/or may be configured to perform some or all of the steps of the methods provided by various embodiments. It should be noted that FIG. 9 is meant only to provide a generalized illustration of various components, any or all of which may be utilized as appropriate. FIG. 9, therefore, broadly illustrates how individual system elements may be implemented in a relatively separated or relatively more integrated manner.

In the illustrated example, computer system 900 includes a communication medium 902, one or more processor(s) 904, one or more input device(s) 906, one or more output device(s) 908, a communications subsystem 910, one or more memory device(s) 912, a baseband system 920, a radio system 922, and an antenna system 924. Computer system 900 may be implemented using various hardware implementations and embedded system technologies. For example, one or more elements of computer system 900 may be implemented within an integrated circuit (IC), an application-specific integrated circuit (ASIC), an application-specific standard product (ASSP), a field-programmable gate array (FPGA), such as those commercially available by XILINX®, INTEL®, or LATTICE SEMICONDUCTOR®, a system-on-a-chip (SoC), a microcontroller, a printed circuit board (PCB), and/or a hybrid device, such as an SoC FPGA, among other possibilities.

The various hardware elements of computer system 900 may be communicatively coupled via communication medium 902. While communication medium 902 is illustrated as a single connection for purposes of clarity, it should be understood that communication medium 902 may include various numbers and types of communication media for transferring data between hardware elements. For example, communication medium 902 may include one or more wires (e.g., conductive traces, paths, or leads on a PCB or integrated circuit (IC), microstrips, striplines, coaxial cables), one or more optical waveguides (e.g., optical fibers, strip waveguides), and/or one or more wireless connections or links (e.g., infrared wireless communication, radio communication, microwave wireless communication), among other possibilities.

In some embodiments, communication medium 902 may include one or more buses that connect the pins of the hardware elements of computer system 900. For example, communication medium 902 may include a bus that connects processor(s) 904 with main memory 914, referred to as a system bus, and a bus that connects main memory 914 with input device(s) 906 or output device(s) 908, referred to as an expansion bus. The system bus may itself consist of several buses, including an address bus, a data bus, and a control bus. The address bus may carry a memory address from processor(s) 904 to the address bus circuitry associated with main memory 914 in order for the data bus to access and carry the data contained at the memory address back to processor(s) 904. The control bus may carry commands from processor(s) 904 and return status signals from main memory 914. Each bus may include multiple wires for carrying multiple bits of information and each bus may support serial or parallel transmission of data.

Processor(s) 904 may include one or more central processing units (CPUs), graphics processing units (GPUs), neural network processors or accelerators, digital signal processors (DSPs), and/or other general-purpose or special-purpose processors capable of executing instructions. A CPU may take the form of a microprocessor, which may be fabricated on a single IC chip of metal–oxide–semiconductor field-effect transistor (MOSFET) construction. Processor(s) 904 may include one or more multi-core processors, in which each core may read and execute program instructions concurrently with the other cores, increasing speed for programs that support multithreading.

Input device(s) 906 may include one or more of various user input devices such as a mouse, a keyboard, a microphone, as well as various sensor input devices, such as an image capture device, a temperature sensor (e.g., thermometer, thermocouple, thermistor), a pressure sensor (e.g., barometer, tactile sensor), a movement sensor (e.g., accelerometer, gyroscope, tilt sensor), a light sensor (e.g., photodiode, photodetector, charge-coupled device), and/or the like. Input device(s) 906 may also include devices for reading and/or receiving removable storage devices or other removable media. Such removable media may include optical discs (e.g., Blu-ray discs, DVDs, CDs), memory cards (e.g., CompactFlash card, Secure Digital (SD) card, Memory Stick), floppy disks, Universal Serial Bus (USB) flash drives, external hard disk drives (HDDs) or solid-state drives (SSDs), and/or the like.

Output device(s) 908 may include one or more of various devices that convert information into human-readable form, such as without limitation a display device, a speaker, a printer, a haptic or tactile device, and/or the like. Output device(s) 908 may also include devices for writing to removable storage devices or other removable media, such as those described in reference to input device(s) 906. Output device(s) 908 may also include various actuators for causing physical movement of one or more components. Such actuators may be hydraulic, pneumatic, electric, and may be controlled using control signals generated by computer system 900.

Communications subsystem 910 may include hardware components for connecting computer system 900 to systems or devices that are located external to computer system 900, such as over a computer network. In various embodiments, communications subsystem 910 may include a wired communication device coupled to one or more input/output ports (e.g., a universal asynchronous receiver-transmitter (UART)), an optical communication device (e.g., an optical modem), an infrared communication device, a radio communication device (e.g., a wireless network interface controller, a BLUETOOTH® device, an IEEE 802.11 device, a Wi-Fi device, a Wi-Max device, a cellular device), among other possibilities.

Memory device(s) 912 may include the various data storage devices of computer system 900. For example, memory device(s) 912 may include various types of computer memory with various response times and capacities, from faster response times and lower capacity memory, such as processor registers and caches (e.g., L0, L1, L2), to medium response time and medium capacity memory, such as random-access memory (RAM), to lower response times and lower capacity memory, such as solid-state drives and hard drive disks. While processor(s) 904 and memory device(s) 912 are illustrated as being separate elements, it should be understood that processor(s) 904 may include varying levels of on-processor memory, such as processor registers and caches that may be utilized by a single processor or shared between multiple processors.

Memory device(s) 912 may include main memory 914, which may be directly accessible by processor(s) 904 via the address and data buses of communication medium 902. For example, processor(s) 904 may continuously read and execute instructions stored in main memory 914. As such, various software elements may be loaded into main memory 914 to be read and executed by processor(s) 904 as illustrated in FIG. 9. Typically, main memory 914 is volatile memory, which loses all data when power is turned off and accordingly needs power to preserve stored data. Main memory 914 may further include a small portion of non-volatile memory containing software (e.g., firmware, such as BIOS) that is used for reading other software stored in memory device(s) 912 into main memory 914. In some embodiments, the volatile memory of main memory 914 is implemented as RAM, such as dynamic random-access memory (DRAM), and the non-volatile memory of main memory 914 is implemented as read-only memory (ROM), such as flash memory, erasable programmable read-only memory (EPROM), or electrically erasable programmable read-only memory (EEPROM).

Computer system 900 may include software elements, shown as being currently located within main memory 914, which may include an operating system, device driver(s), firmware, compilers, and/or other code, such as one or more application programs, which may include computer programs provided by various embodiments of the present disclosure. Merely by way of example, one or more steps described with respect to any methods discussed above, may be implemented as instructions 916, which are executable by computer system 900. In one example, such instructions 916 may be received by computer system 900 using communications subsystem 910 (e.g., via a wireless or wired signal that carries instructions 916), carried by communication medium 902 to memory device(s) 912, stored within memory device(s) 912, read into main memory 914, and executed by processor(s) 904 to perform one or more steps of the described methods. In another example, instructions 916 may be received by computer system 900 using input device(s) 906 (e.g., via a reader for removable media), carried by communication medium 902 to memory device(s) 912, stored within memory device(s) 912, read into main memory 914, and executed by processor(s) 904 to perform one or more steps of the described methods.

Computer system 900 may include optional wireless communication components that facilitate wireless communication over a voice network and/or a data network. The wireless communication components comprise an antenna system 924, a radio system 922, and a baseband system 920. In computer system 900, RF signals are transmitted and received over the air by antenna system 924 under the management of radio system 922. In an embodiment, antenna system 924 may comprise one or more antennae and one or more multiplexors (not shown) that perform a switching function to provide antenna system 924 with transmit and receive signal paths. In the reception path, received RF signals can be coupled from a multiplexor to a low noise amplifier (not shown) that amplifies the received RF signal and sends the amplified signal to radio system 922. In an alternative embodiment, radio system 922 may comprise one or more radios that are configured to communicate over various frequencies. In an embodiment, radio system 922 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 922 to baseband system 920.

In some embodiments of the present disclosure, instructions 916 are stored on a computer-readable storage medium (or simply computer-readable medium). Such a computer-readable medium may be non-transitory and may therefore be referred to as a non-transitory computer-readable medium. In some cases, the non-transitory computer-readable medium may be incorporated within computer system 900. For example, the non-transitory computer-readable medium may be one of memory device(s) 912 (as shown in FIG. 9). In some cases, the non-transitory computer-readable medium may be separate from computer system 900. In one example, the non-transitory computer-readable medium may be a removable medium provided to input device(s) 906 (as shown in FIG. 9), such as those described in reference to input device(s) 906, with instructions 916 being read into computer system 900 by input device(s) 906. In another example, the non-transitory computer-readable medium may be a component of a remote electronic device, such as a mobile phone, that may wirelessly transmit a data signal that carries instructions 916 to computer system 900 and that is received by communications subsystem 910 (as shown in FIG. 9).

Instructions 916 may take any suitable form to be read and/or executed by computer system 900. For example, instructions 916 may be source code (written in a human-readable programming language such as Java, C, C++, C#, Python), object code, assembly language, machine code, microcode, executable code, and/or the like. In one example, instructions 916 are provided to computer system 900 in the form of source code, and a compiler is used to translate instructions 916 from source code to machine code, which may then be read into main memory 914 for execution by processor(s) 904. As another example, instructions 916 are provided to computer system 900 in the form of an executable file with machine code that may immediately be read into main memory 914 for execution by processor(s) 904. In various examples, instructions 916 may be provided to computer system 900 in encrypted or unencrypted form, compressed or uncompressed form, as an installation package or an initialization for a broader software deployment, among other possibilities.

In one aspect of the present disclosure, a system (e.g., computer system 900) is provided to perform methods in accordance with various embodiments of the present disclosure. For example, some embodiments may include a system comprising one or more processors (e.g., processor(s) 904) that are communicatively coupled to a non-transitory computer-readable medium (e.g., memory device(s) 912 or main memory 914). The non-transitory computer-readable medium may have instructions (e.g., instructions 916) stored therein that, when executed by the one or more processors, cause the one or more processors to perform the methods described in the various embodiments.

In another aspect of the present disclosure, a computer-program product that includes instructions (e.g., instructions 916) is provided to perform methods in accordance with various embodiments of the present disclosure. The computer-program product may be tangibly embodied in a non-transitory computer-readable medium (e.g., memory device(s) 912 or main memory 914). The instructions may be configured to cause one or more processors (e.g., processor(s) 904) to perform the methods described in the various embodiments.

In another aspect of the present disclosure, a non-transitory computer-readable medium (e.g., memory device(s) 912 or main memory 914) is provided. The non-transitory computer-readable medium may have instructions (e.g., instructions 916) stored therein that, when executed by one or more processors (e.g., processor(s) 904), cause the one or more processors to perform the methods described in the various embodiments.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

As used herein and in the appended claims, the singular forms “a”, “an”, and “the” include plural references unless the context clearly dictates otherwise. Thus, for example, reference to “a user” includes reference to one or more of such users, and reference to “a processor” includes reference to one or more processors and equivalents thereof known to those skilled in the art, and so forth.

Also, the words “comprise,” “comprising,” “contains,” “containing,” “include,” “including,” and “includes,” when used in this specification and in the following claims, are intended to specify the presence of stated features, integers, components, or steps, but they do not preclude the presence or addition of one or more other features, integers, components, steps, acts, or groups.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A method of orchestrating radio frequency transmissions directed toward a monitoring satellite, the method comprising:
determining a target arrival time at which signals are to arrive at the monitoring satellite;
calculating, for each of a plurality of signal generator sites distributed at distinct geographic locations, a propagation delay from the respective signal generator site to the monitoring satellite;
determining a start time for each of the plurality of signal generator sites based on the target arrival time and the calculated propagation delay, such that signals transmitted by the plurality of signal generator sites arrive at the monitoring satellite substantially simultaneously;
communicating, via a communication link, the determined start time to each of the plurality of signal generator sites; and
causing each of the plurality of signal generator sites to transmit a signal at the determined start time.

2. The method of claim 1, wherein the determining, calculating, and communicating are performed by a centralized controller located at an operations center.

3. The method of claim 1, wherein the arrival of the signals at the monitoring satellite creates a combined signal that prevents isolation of any individual signal generator site by time difference of arrival (TDoA) or frequency difference of arrival (FDoA) techniques.

4. The method of claim 1, further comprising:
calculating a path loss from each of the plurality of signal generator sites to the monitoring satellite;
determining a transmit power level for each of the plurality of signal generator sites based on the calculated path loss, such that the signals arrive at the monitoring satellite with substantially identical power levels; and
communicating the transmit power level to each of the plurality of signal generator sites.

5. The method of claim 1, wherein causing each of the plurality of signal generator sites to transmit the signal comprises:
instantiating a signal generator Virtual Network Function (VNF) on a compute infrastructure located at each signal generator site; and
generating, by the signal generator VNF, a digital waveform for transmission via a digitizer and an antenna.

6. The method of claim 5, further comprising:
deactivating and removing the signal generator VNF from the compute infrastructure upon completion of the transmission.

7. The method of claim 1, wherein the signal transmitted by each of the plurality of signal generator sites comprises a noise source, a continuous wave carrier tone, or a modulated waveform containing dummy data or actual data.

8. The method of claim 1, wherein the signals transmitted by the plurality of signal generator sites overlap in time and frequency at the monitoring satellite but are not strictly phase-coherent with one another.

9. The method of claim 1, wherein the signals transmitted are not intended to be decoded by a receiver and do not require successful data demodulation.

10. The method of claim 1, further comprising:
dynamically updating the start time for each of the plurality of signal generator sites based on a changing orbital position of the monitoring satellite.

11. A system for orchestrating signal transmission, comprising:
a plurality of signal generator sites distributed at distinct geographic locations, each site comprising an antenna and a network interface; and
one or more processors communicatively coupled to the plurality of signal generator sites, the one or more processors configured to:
determine a location of a monitoring satellite;
calculate a propagation delay from each of the plurality of signal generator sites to the monitoring satellite;
determine a start time for each of the plurality of signal generator sites based on the calculated propagation delay; and
command the plurality of signal generator sites to transmit signals according to the determined start time;
wherein the one or more processors orchestrate the transmission such that the signals from the plurality of signal generator sites overlap in time at the monitoring satellite.

12. The system of claim 11, wherein the one or more processors constitute a centralized controller geographically distant from at least one of the plurality of signal generator sites.

13. The system of claim 11, wherein the signals overlap in time at the monitoring satellite to create a combined signal that prevents isolation of any individual signal generator site by time difference of arrival (TDoA) or frequency difference of arrival (FDoA) techniques.

14. The system of claim 11, wherein the one or more processors are further configured to:
calculate a path loss from each of the plurality of signal generator sites to the monitoring satellite; and
determine a transmit power level for each of the plurality of signal generator sites such that the signals arrive at the monitoring satellite with substantially identical power levels.

15. The system of claim 11, wherein each of the plurality of signal generator sites further comprises:
a compute infrastructure configured to execute a Virtual Network Function (VNF); and
a digitizer coupled between the compute infrastructure and the antenna.

16. The system of claim 15, wherein the one or more processors are further configured to command the instantiation of a signal generator VNF on the compute infrastructure of each site prior to the determined start time.

17. The system of claim 15, wherein the signal generator VNF is configured to generate digital Intermediate Frequency (IF) packets, and the digitizer is configured to convert the digital IF packets into an analog RF signal.

18. One or more non-transitory computer-readable media comprising instructions that, when executed by one or more processors, cause the one or more processors to perform operations comprising:
identifying a set of available signal generator sites surrounding a monitoring antenna site;
calculating a propagation delay from each of the set of signal generator sites to a monitoring satellite associated with the monitoring antenna site;
determining a transmission start time for each of the set of signal generator sites to ensure that signals transmitted from the sites arrive at the monitoring satellite substantially simultaneously; and
transmitting commands to the set of signal generator sites to initiate signal transmission at the determined transmission start times.

19. The one or more non-transitory computer-readable media of claim 18, wherein the instructions further cause the one or more processors to perform operations comprising:
determining a transmit power for each of the set of signal generator sites to ensure that the signals arrive at the monitoring satellite with substantially equal power.

20. The one or more non-transitory computer-readable media of claim 18, wherein determining the transmission start time comprises subtracting the calculated propagation delay from a target arrival time at the monitoring satellite.
